(19) United States
(12) Patent Application Publication
(10) Pub. No.: US 2016/0275898 A1
(43) Pub. Date: Sep. 22, 2016

(54) DRIVING METHOD FOR DISPLAY APPARATUS AND CIRCUITRY OF DISPLAY APPARATUS USED THEREIN

(71) Applicant: Shenzhen China Star Optoelectronics Technology Co., Ltd., Shenzhen, Guangdong (CN)

(72) Inventors: Jiehui Qin, Shenzhen, Guangdong (CN); Wei CHEN, Shenzhen, Guangdong (CN); Xiaoping TAN, Shenzhen, Guangdong (CN)

(73) Assignee: Shenzhen China Star Optoelectronics Technology Co., Ltd., Shenzhen, guangdong (CN)

(21) Appl. No.: 14/371,736

(22) PCT Filed: Jul. 2, 2014
(86) PCT No.: PCT/CN2014/081431

§ 371 Date: Jul. 11, 2014

(30) Foreign Application Priority Data
May 20, 2014 (CN) 201410214554.1

(51) Int. Cl. G09G 3/36; G09G 3/3291

(52) U.S. Cl. CPC G09G 3/3696; G09G 3/3291; G09G 2300/0426

(57) ABSTRACT

The present invention provides a driving method for display apparatus and circuitry of display apparatus used therein. The driving method comprises providing a pre-clock signal (CPV), a charge sharing control signal (GCS), a clock signal (CK), which swings between a high voltage signal (VH) and a low voltage signal (VL), formed basing on the pre-clock signal (CPV) and the charge sharing control signal (GCS); setting the pre-clock signal (CPV) to “1” when it is high, and setting it to “0” when it is low; setting the charge sharing control signal (GCS) to “1” when it is high, and setting it to “0” when it is low; and triggering the clock signal (CK) to rise to an intermediate voltage signal (VF) from the low voltage signal (VL) or to fall to the intermediate voltage signal (VF) from the high voltage signal (VH) when the charge sharing control signal (GCS) is set to “1” and the pre-clock signal (CPV) is set to “1”.

### FIELD OF THE INVENTION

The present invention relates to the field of display apparatus, and more particularly to a driving method for display apparatus and circuitry of display apparatus used therein.

### BACKGROUND OF THE INVENTION

A display apparatus, such as liquid crystal display (LCD), includes two display panels and a dielectric anisotropy liquid crystal layer disposed between the two display panels, wherein one of the display panels has pixel electrodes while another one has common electrodes. The LCD applies voltages to the two electrodes to form electric field in the liquid crystal layer, and the liquid crystal layer provides an image by controlling light transmittance through the liquid crystal layer. The image would be degraded for applying the electric field on a same direction for a long time. In order to prevent the image from being degraded, the polarity of data voltage related to the common voltage is periodically reversed per frame, column or pixel.

A circuitry of the LCD includes: a gate driver for transmitting gate signal to gate lines for turning on/off switching element of each pixel; a grey-level voltage generator for generating a plurality of grey-level voltages; a data driver for selecting voltage corresponding to the image data from the grey-level voltages and applying the selected data voltage to data lines in the display signal lines; and a signal controller for controlling these circuitry elements. The gate driver is manufactured by the same process for manufacturing the switching element of the pixel and is integrated into the panel thereafter. By reducing data line to half amount but not increasing the gate line to double amount, the same resolution can be achieved and the cost is lowered. Furthermore, a pair of gate drivers for applying gate signals are set on the panel, wherein one of the pair of gate drivers is set on left side of the panel and another one of the pair of gate drivers is set on right side of the panel. In order to apply the gate signals in a frame period, a following gate signal is overlapped with a prior gate signal by transmitting the following gate signal after a predetermined time passed from applying the prior gate signal.

A parasitic capacitor is formed in the pixel when the signal lines are overlapped. After being applied, the data voltage is slightly reduced due to the kickback voltage generated by the parasitic capacitor on the falling edge. After that, the data voltage is reduced again due to the kickback voltage generated on the falling edge of the following gate signal. The voltage difference between positive pixel voltage and negative pixel voltage is generated and therefore leads to blinking. In the LCD, the kickback voltage proportional to the voltage difference between the gate on voltage and gate off voltage leads to problems such as display blinking and increasingly power consumption.

The problems caused by the kickback voltage can be improved by triggering an intermediate voltage. Referring to FIG. 1, which is a timing diagram of clock signals, such as a first pre-clock signal (CPV1), a first charge sharing control signal (GCS1), and a first clock signal (CK1), in a conventional display apparatus. There includes the first pre-clock signal (CPV1), the first charge sharing control signal (GCS1), and a first clock signal (CK1) which is formed basing on the first pre-clock signal (CPV1) and the first charge sharing control signal (GCS1) and swings between the high voltage signal (VH) and the low voltage signal (VL). The first pre-clock signal (CPV1) is set to “1” when it is high, and is set to “0” when it is low. The first charge sharing control signal (GCS1) is set to “1” when it is high, and is set to “0” when it is low. The first clock signal (CK1) is switched to the intermediate voltage signal (VF) from the low voltage signal (VL) before the rising edge of the first pre-clock signal (CPV1) when the first pre-clock signal (CPV1) is set to “0” and the first charge sharing control signal (GCS1) is set to “1”. The first charge sharing control signal (GCS1) is set to “0” after the rising edge of the first pre-clock signal (CPV1) such that the first clock signal (CK1) is switched to the high voltage signal (VH) from the intermediate voltage signal (VF). The first clock signal (CK1) is switched to the intermediate voltage signal (VF) from the high voltage signal (VH) before the falling edge of the first pre-clock signal (CPV1) when the first pre-clock signal (CPV1) is set to “1” and the first charge sharing control signal (GCS1) is set to “1”. The first charge sharing control signal (GCS1) is set to “0” after the falling edge of the first pre-clock signal (CPV1) such that the first clock signal (CK1) is switched to the low voltage signal (VL) from the intermediate voltage signal (VF). The status of second pre-clock signal (CPV2) till the n^{th} pre-clock signal (CPVn) can be deduced by analogy, and the conducting timing can be obtained from timing sequence when needed.

The pre-charge occurred when the charge sharing control signal (GCS) triggers the intermediate voltage signal (VF) before the rising edge of the pre-clock signal (CPV1) in the conventional technique can improve the response time of the circuitry. However, it is possible to make the waveforms of the multiple clock signals (CK1˜CKn) overlap.

### SUMMARY OF THE INVENTION

An object of the present invention is to provide a driving method for display apparatus such that the overlapping of clock signals which results in waveform confusion might be avoided effectively, and power consumption and kickback voltage generated when the clock signal falls from the high voltage to the low voltage or rises from the low voltage to the high voltage can be improved.

Another object of the present invention is to provide a circuitry of display apparatus used in the driving method such that the kickback voltage generated when the clock signal falls from the high voltage to the low voltage or rises from the low voltage to the high voltage can be improved by turning on and off the switches and transistors in the circuitry according to the pre-clock signal and the charge sharing control signal.

The present invention provides a driving method for display apparatus, comprising:
a step 100, providing a pre-clock signal (CPV) and a charge sharing control signal (GCS);
a step 110, providing a clock signal (CK), which swings between a high voltage signal (VH) and a low voltage signal (VL), formed basing on the pre-clock signal (CPV) and the charge sharing control signal (GCS);
a step 120, setting the pre-clock signal (CPV) to “1” when the pre-clock signal (CPV) is high, and setting the pre-clock signal (CPV) to “0” when the pre-clock signal (CPV) is low; setting the charge sharing control signal (GCS) to “1” when the charge sharing control signal (GCS) is high, and setting the charge sharing control signal (GCS) to “0” when the charge sharing control signal (GCS) is low; and
a step 130, triggering the clock signal (CK) to rise to an intermediate voltage signal (VF) from the low voltage signal (VL) or to fall to the intermediate voltage signal (VF) from the high voltage signal (VH) when the charge sharing control signal (GCS) is set to “1” and the pre-clock signal (CPV) is set to “1”.

The step 130 further comprises: triggering the clock signal (CK) to rise to the high voltage signal (VH) from the intermediate voltage signal (VF) or to fall to the low voltage signal (VL) from the intermediate voltage signal (VF) when the charge sharing control signal (GCS) is set to “0” and the pre-clock signal (CPV) is set to “1”.

There are plural pre-clock signals (CPV), plural charge sharing control signals (GCS) and plural clock signals (CK).

The present invention further provides a driving method for display apparatus, comprising:
a step 100, providing a pre-clock signal (CPV) and a charge sharing control signal (GCS);
a step 110, providing a clock signal (CK), which swings between a high voltage signal (VH) and a low voltage signal (VL), formed basing on the pre-clock signal (CPV) and the charge sharing control signal (GCS);
a step 120, setting the pre-clock signal (CPV) to “1” when the pre-clock signal (CPV) is high, and setting the pre-clock signal (CPV) to “0” when the pre-clock signal (CPV) is low; setting the charge sharing control signal (GCS) to “1” when the charge sharing control signal (GCS) is high, and setting the charge sharing control signal (GCS) to “0” when the charge sharing control signal (GCS) is low; and
a step 130, triggering the clock signal (CK) to rise to an intermediate voltage signal (VF) from the low voltage signal (VL) or to fall to the intermediate voltage signal (VF) from the high voltage signal (VH) when the charge sharing control signal (GCS) is set to “1” and the pre-clock signal (CPV) is set to “1”;
wherein the step 130 further comprises triggering the clock signal (CK) to rise to the high voltage signal (VH) from the intermediate voltage signal (VF) or to fall to the low voltage signal (VL) from the intermediate voltage signal (VF) when the charge sharing control signal (GCS) is set to “0” and the pre-clock signal (CPV) is set to “1”;
wherein there are plural pre-clock signals (CPV), plural charge sharing control signals (GCS) and plural clock signals (CK).

The present invention further provides a circuitry of display apparatus, comprising a high voltage signal (VH), a low voltage signal (VL), an intermediate voltage signal (VF), a pre-clock signal (CPV), a charge sharing control signal (GCS), a clock signal (CK) swinging between the high voltage signal (VH) and the low voltage signal (VL) and formed basing on the pre-clock signal (CPV) and the charge sharing control signal (GCS), a first switch (SW1), a second switch (SW2), a third switch (SW3), a first transistor (T1) and a second transistor (T2).

The first transistor (T1) comprises a first gate (G1), a first collector (c1) and a first emitter (e1). The second transistor (T2) comprises a second gate (G2), a second collector (c2) and a second emitter (e2). A terminal of the first switch (SW1) is electrically coupled to the first emitter (e1), and another terminal of the first switch (SW1) is electrically coupled to the clock signal (CK). A terminal of the second switch (SW2) is electrically coupled to the second collector (c2), and another terminal of the second switch (SW2) is electrically coupled to the clock signal (CK). A terminal of the third switch (SW3) is electrically coupled to the intermediate voltage signal (VF), and another terminal of the third switch (SW3) is electrically coupled to the clock signal (CK). The first gate (G1) is electrically coupled to the pre-clock signal (CPV), and the second gate (G2) is electrically coupled to the pre-clock signal (CPV). The first collector (c1) is electrically coupled to the high voltage signal (VH), and the second emitter (e2) is electrically coupled to the low voltage signal (VL).

The pre-clock signal (CPV) is set to “1” when it is high, and the pre-clock signal (CPV) is set to “0” when it is low. The charge sharing control signal (GCS) is set to “1” when it is high, and the charge sharing control signal (GCS) is set to “0” when it is low.

The conductivity of the high voltage signal (VH) and the low voltage signal (VL) is controlled by the pre-clock signal (CPV).

The first switch (SW1) and second switch (SW2) are turning on when the charge sharing control signal (GCS) is set to “0”; the third switch (SW3) is turning on when the charge sharing control signal (GCS) is set to “1”.

The pre-clock signal (CPV) and the charge sharing control signal (GCS) controls turning on/off of the first switch (SW1), the second switch (SW2), the third switch (SW3), the first transistor (T1) and the second transistor (T2) to choose one of the high voltage signal (VH), the low voltage signal (VL) and the intermediate voltage signal (VF) for outputting as the clock signal (CK).

The first transistor (T1) and the second transistor (T2) are insulated gate bipolar transistors.

There are plural pre-clock signals (CPV), plural charge sharing control signals (GCS) and plural clock signals (CK).

The beneficial effect of the present invention is: the present invention provides a driving method of display apparatus and circuitry of display apparatus used therein, wherein the clock signal (CK) is triggered to rise to the intermediate voltage signal (VF) from the low voltage signal (VL) or to fall to the intermediate voltage signal (VF) from the high voltage signal (VH) when the charge sharing control signal (GCS) is set to “1” and the pre-clock signal (CPV) is set to “1”, such that overlapping of clock signals which results in waveform confusion might be avoided effectively by setting time point that triggering the intermediate voltage in the time period when the pre-clock signal is set to “1”. Furthermore, power consumption and kickback voltage generated when the clock signal falls from the high voltage to the low voltage or rises from the low voltage to the high voltage can be improved accordingly.

Please refer to the detailed description and the attached drawings for understanding the feature and technique content of the present invention. The attached drawings are only for providing reference and explanation but not for limiting the present invention.

### BRIEF DESCRIPTION OF THE DRAWINGS

The technique contents and other beneficial effects of the present invention will become more readily apparent to those ordinarily skilled in the art through detailed description with accompanying drawings.

In the drawings:

FIG. 1 is a timing sequence of a clock signal in conventional display apparatus.

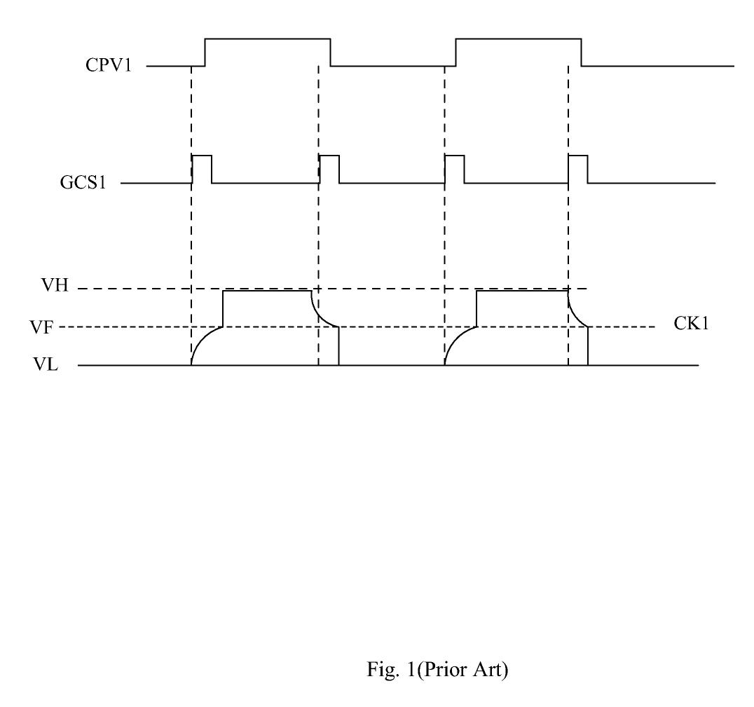

FIG. 2 is a flow chart of the driving method for display apparatus according to one embodiment of the present invention.

FIG. 3 is a timing sequence of clock signals in display apparatus according to one embodiment of the present invention.

FIG. 4 is a schematic diagram of a circuitry in the display apparatus according to one embodiment of the present invention.

### DETAILED DESCRIPTION OF PREFERRED EMBODIMENTS

In order to more specifically describe the technical means and the effects of the present invention, the best embodiments and drawings are described in detail as follows.

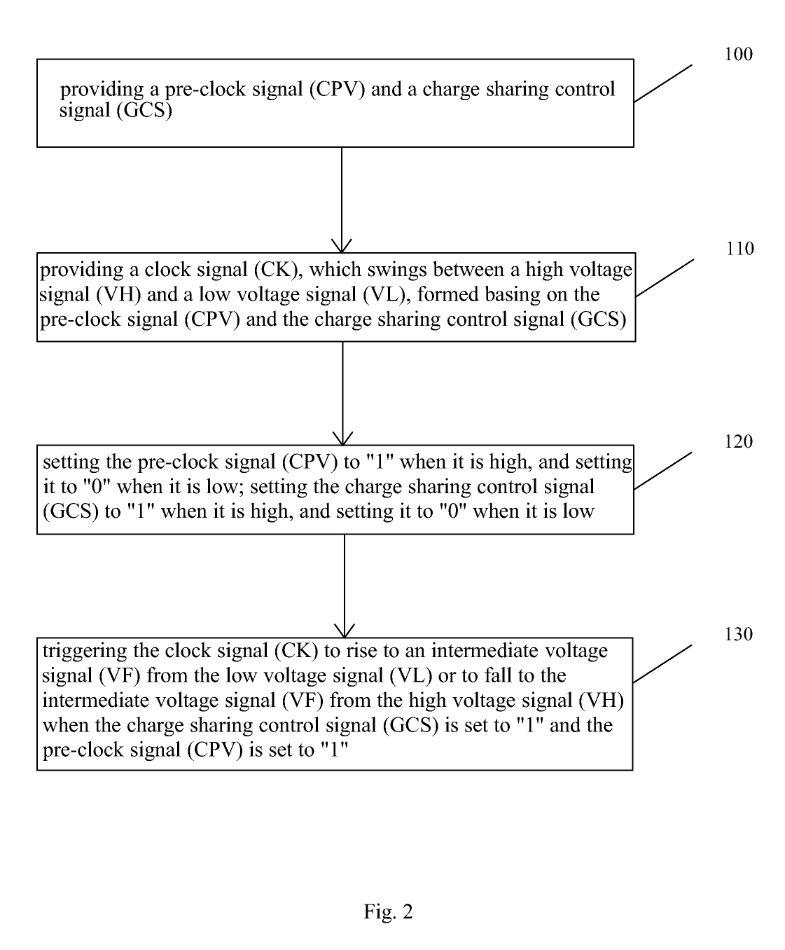

Please refer to FIG. 2. The present invention provides a driving method for display apparatus, comprising:
a step 100, providing a pre-clock signal (CPV) and a charge sharing control signal (GCS);
a step 110, providing a clock signal (CK), which swings between a high voltage signal (VH) and a low voltage signal (VL), formed basing on the pre-clock signal (CPV) and the charge sharing control signal (GCS);
a step 120, setting the pre-clock signal (CPV) to “1” when the pre-clock signal (CPV) is high, and setting the pre-clock signal (CPV) to “0” when the pre-clock signal (CPV) is low; setting the charge sharing control signal (GCS) to “1” when the charge sharing control signal (GCS) is high, and setting the charge sharing control signal (GCS) to “0” when the charge sharing control signal (GCS) is low; and
a step 130, triggering the clock signal (CK) to rise to an intermediate voltage signal (VF) from the low voltage signal (VL) or to fall to the intermediate voltage signal (VF) from the high voltage signal (VH) when the charge sharing control signal (GCS) is set to “1” and the pre-clock signal (CPV) is set to “1”.

The step 130 further comprise: triggering the clock signal (CK) to rise to the high voltage signal (VH) from the intermediate voltage signal (VF) or to fall to the low voltage signal (VL) from the intermediate voltage signal (VF) when the charge sharing control signal (GCS) is set to “0” and the pre-clock signal (CPV) is set to “1”.

There are plural pre-clock signals (CPV), plural charge sharing control signals (GCS) and plural clock signals (CK).

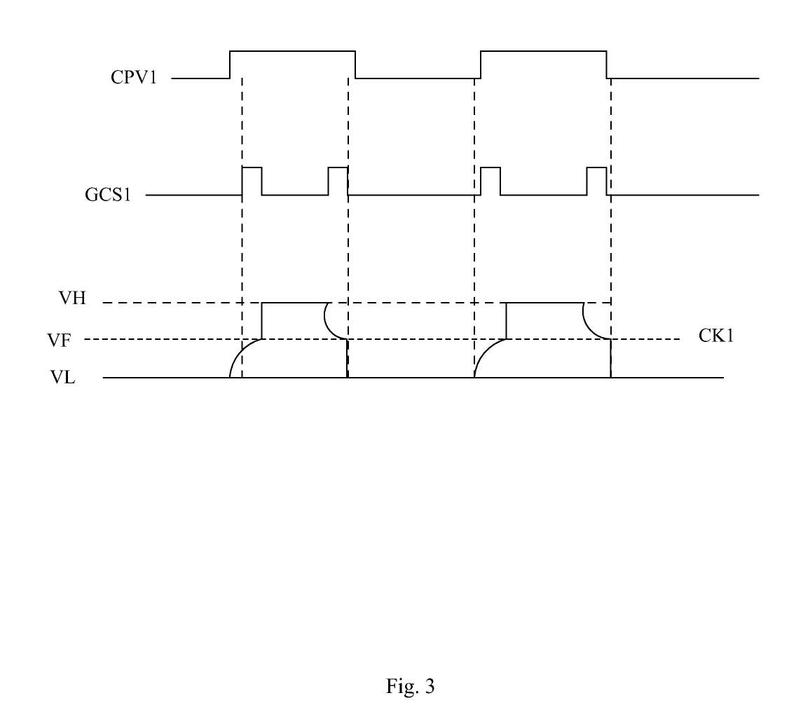

Please refer to FIG. 3, which is a timing sequence of clock signals in display apparatus according to one embodiment of the present invention, illustrated for example by using a first pre-clock signal (CPV1), a first charge sharing control signal (GCS1) and a first clock signal (CK1). In FIG. 3, there comprises a first pre-clock signal (CPV1), a first charge sharing control signal (GCS1), and a first clock signal (CK1), which swings between a high voltage signal (VH) and a low voltage signal (VL), formed basing on the first pre-clock signal (CPV1) and the first charge sharing control signal (GCS1). The first pre-clock signal (CPV1) is set to “1” when the first pre-clock signal (CPV1) is high, and is set to “0” when the first pre-clock signal (CPV1) is low. The first charge sharing control signal (GCS1) is set to “1” when the first charge sharing control signal (GCS1) is high, and is set to “0” when the first charge sharing control signal (GCS1) is low. In the time period when the first pre-clock signal (CPV1) is set to “1”, the first charge sharing control signal (GCS1) is firstly set to “1” for switching the first clock signal (CK1) to the intermediate voltage signal (VF) from the low voltage signal (VL), and then the first charge sharing control signal (GCS1) is set to “0” for switching the first clock signal (CK1) to the high voltage signal (VH) from the intermediate voltage signal (VF); after that, the first charge sharing control signal (GCS1) is set to “1” for switching the first clock signal (CK1) to the intermediate voltage signal (VF) from the high voltage signal (VH), and then, the first charge sharing control signal (GCS1) is set to “0” for switching the first clock signal (CK1) to the low voltage signal (VL) from the intermediate voltage signal (VF). By setting time point that triggering the intermediate voltage (VF) in the time period when the first pre-clock signal (CPV1) is set to “1”, overlapping of plural clock signals (CK1, . . . CKn) which results in waveform confusion might be avoided effectively.

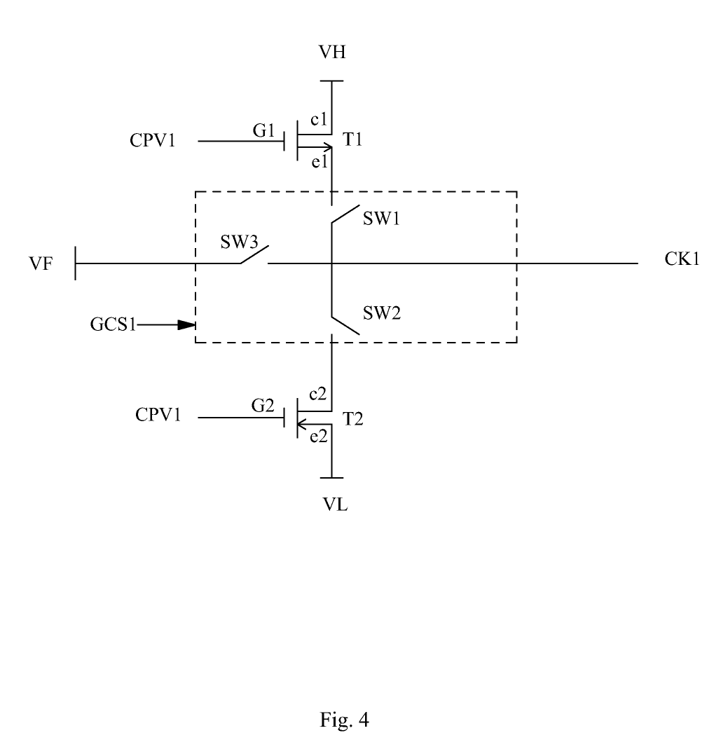

Please refer to FIG. 4 in view of FIG. 3, wherein FIG. 4 is a schematic diagram of a circuitry in the display apparatus according to one embodiment of the present invention, illustrated for example by using the first pre-clock signal (CPV1), the first charge sharing control signal (GCS1) and the first clock signal (CK1). The present invention further provides a circuitry of display apparatus used in the above mentioned driving method. The circuitry comprising a high voltage signal (VH), a low voltage signal (VL), an intermediate voltage signal (VF), a first pre-clock signal (CPV1), a first charge sharing control signal (GCS1), a first clock signal (CK1) swinging between the high voltage signal (VH) and the low voltage signal (VL) and formed basing on the first pre-clock signal (CPV1) and the first charge sharing control signal (GCS1), a first switch (SW1), a second switch (SW2), a third switch (SW3), a first transistor (T1) and a second transistor (T2). The first transistor (T1) comprises a first gate (G1), a first collector (c1) and a first emitter (e1). The second transistor (T2) comprises a second gate (G2), a second collector (c2) and a second emitter (e2). A terminal of the first switch (SW1) is electrically coupled to the first emitter (e1), and another terminal of the first switch (SW1) is electrically coupled to the first clock signal (CK1). A terminal of the second switch (SW2) is electrically coupled to the second collector (c2), and another terminal of the second switch (SW2) is electrically coupled to the first clock signal (CK1). A terminal of the third switch (SW3) is electrically coupled to the intermediate voltage signal (VF), and another terminal of the third switch (SW3) is electrically coupled to the first clock signal (CK1). The first gate (G1) is electrically coupled to the first pre-clock signal (CPV1), and the second gate (G2) is electrically coupled to the first pre-clock signal (CPV1) as well. The first collector (c1) is electrically coupled to the high voltage signal (VH), and the second emitter (e2) is electrically coupled to the low voltage signal (VL). Conductivity of the high voltage signal (VH) and the low voltage signal (VL) is controlled by the first pre-clock signal (CPV1).

The first transistor (T1) and the second transistor (T2) are insulated gate bipolar transistors (IGBTs).

The status of second pre-clock signal (CPV2) till the n^{th} pre-clock signal (CPVn) can be deduced by analogy, and the conducting timing can be obtained from timing sequence when needed.

Accordingly, the present invention provides a driving method of display apparatus and circuitry of display apparatus used therein, wherein the clock signal (CK) is triggered to rise to the intermediate voltage signal (VF) from the low voltage signal (VL) or to fall to the intermediate voltage signal (VF) from the high voltage signal (VH) when the charge sharing control signal (GCS) is set to “1” and the pre-clock signal (CPV) is set to “1”. Overlapping of clock signals which results in waveform confusion might be avoided effectively by setting time point that triggering the intermediate voltage in the time period when the pre-clock signal is set to “1”. Furthermore, power consumption and kickback voltage generated when the clock signal falls from the high voltage to the low voltage or rises from the low voltage to the high voltage can be improved accordingly.

Those with ordinary skill in the art are capable of make various modifications and arrangements in accordance to the technical solutions and technical ideas of the present invention, and those modifications and arrangements should be covered by the scope of the appended claims of the present invention.

What is claimed is:

1. A driving method for display apparatus, comprising:
a step 100, providing a pre-clock signal and a charge sharing control signal;
a step 110, providing a clock signal, which swings between a high voltage signal and a low voltage signal, formed basing on the pre-clock signal and the charge sharing control signal;
a step 120, setting the pre-clock signal to “1” when the pre-clock signal is high, and setting the pre-clock signal to “0” when the pre-clock signal is low; setting the charge sharing control signal to “1” when the charge sharing control signal is high, and setting the charge sharing control signal to “0” when the charge sharing control signal is low; and
a step 130, triggering the clock signal to rise to an intermediate voltage signal from the low voltage signal or to fall to the intermediate voltage signal from the high voltage signal when the charge sharing control signal is set to “1” and the pre-clock signal is set to “1”.

2. The driving method of claim 1, wherein the step 130 further comprises:
triggering the clock signal to rise to the high voltage signal from the intermediate voltage signal or to fall to the low voltage signal from the intermediate voltage signal when the charge sharing control signal is set to “0” and the pre-clock signal is set to “1”.

3. The driving method of claim 1, wherein there are plural pre-clock signals, plural charge sharing control signals and plural clock signals.

4. A driving method for display apparatus, comprising:
a step 100, providing a pre-clock signal and a charge sharing control signal;
a step 110, providing a clock signal, which swings between a high voltage signal and a low voltage signal, formed basing on the pre-clock signal and the charge sharing control signal;
a step 120, setting the pre-clock signal to “1” when the pre-clock signal is high, and setting the pre-clock signal to “0” when the pre-clock signal is low; setting the charge sharing control signal to “1” when the charge sharing control signal is high, and setting the charge sharing control signal to “0” when the charge sharing control signal is low; and
a step 130, triggering the clock signal to rise to an intermediate voltage signal from the low voltage signal or to fall to the intermediate voltage signal from the high voltage signal when the charge sharing control signal is set to “1” and the pre-clock signal is set to “1”;
wherein the step 130 further comprises triggering the clock signal to rise to the high voltage signal from the intermediate voltage signal or to fall to the low voltage signal from the intermediate voltage signal when the charge sharing control signal is set to “0” and the pre-clock signal is set to “1”;
wherein there are plural pre-clock signals, plural charge sharing control signals and plural clock signals.

5. A circuitry of display apparatus, comprising a high voltage signal, a low voltage signal, an intermediate voltage signal, a pre-clock signal, a charge sharing control signal, a clock signal swinging between the high voltage signal and the low voltage signal and formed basing on the pre-clock signal and the charge sharing control signal, a first switch, a second switch, a third switch, a first transistor and a second transistor;
wherein the first transistor comprises a first gate, a first collector and a first emitter, and the second transistor comprises a second gate, a second collector and a second emitter;
wherein a terminal of the first switch is electrically coupled to the first emitter, and another terminal of the first switch is electrically coupled to the clock signal; a terminal of the second switch is electrically coupled to the second collector, and another terminal of the second switch is electrically coupled to the clock signal; a terminal of the third switch is electrically coupled to the intermediate voltage signal, and another terminal of the third switch is electrically coupled to the clock signal; the first gate is electrically coupled to the pre-clock signal, and the second gate is electrically coupled to the pre-clock signal; the first collector is electrically coupled to the high voltage signal, and the second emitter is electrically coupled to the low voltage signal.

6. The circuitry of claim 5, wherein the pre-clock signal is set to “1” when the pre-clock signal is high, and the pre-clock signal is set to “0” when the pre-clock signal is low; the charge sharing control signal is set to “1” when the charge sharing control signal is high, and the charge sharing control signal is set to “0” when the charge sharing control signal is low.

7. The circuitry of claim 6, wherein the first switch and second switch are turning on when the charge sharing control signal is set to “0”; the third switch is turning on when the charge sharing control signal is set to “1”.

8. The circuitry of claim 5, wherein the conductivity of the high voltage signal and the low voltage signal is controlled by the pre-clock signal.

9. The circuitry of claim 8, wherein the pre-clock signal and the charge sharing control signal controls turning on/off of the first switch, the second switch, the third switch, the first transistor and the second transistor to choose one of the high voltage signal, the low voltage signal and the intermediate voltage signal for outputting as the clock signal.

10. The circuitry of claim 5, wherein the first transistor and the second transistor are insulated gate bipolar transistors.

11. the circuitry of claim 5, wherein there are plural pre-clock signals, plural charge sharing control signals and plural clock signals.
